(19) United States
(12) Patent Application Publication
(10) Pub. No.: US 2016/0005074 A1
(43) Pub. Date: Jan. 7, 2016

(54) METHODS AND SYSTEMS FOR DISPLAYING CONTENT ON A DEVICE

(71) Applicant: Mansour Hamdan MANSOUR, Amman (JO)

(72) Inventor: Mansour Hamdan MANSOUR, Amman (JO)

(21) Appl. No.: 14/792,679

(22) Filed: Jul. 7, 2015

Related U.S. Application Data
(60) Provisional application No. 62/021,382, filed on Jul. 7, 2014.

(51) Int. Cl. G06Q 30/02; H04W 4/16; H04M 3/42

(52) U.S. Cl. CPC G06Q 30/0255; G06Q 30/0267; H04M 3/42; H04W 4/16

(57) ABSTRACT

A system for displaying content on a device, the system including a device memory storing a device user profile, and a processor coupled to the device memory and programmed to: (i) retrieve a plurality of contents from one or more servers and store the retrieved plurality of contents in the device memory; (ii) read the device user profile from the device memory; (iii) detect occurrence of a device-related event; (iv) determine, based on the detected occurrence of the device-related event and the read device user profile, presentation content from the stored plurality of contents; and (v) display, on a device display, the determined presentation content.

### CROSS-REFERENCE TO RELATED PATENT APPLICATION

This application claims priority from U.S. Provisional Application No. 62/021,382 filed on Jul. 7, 2014, the disclosure of which is incorporated herein by reference in its entirety.

### BACKGROUND

1. Technical Field

One or more exemplary embodiments relate to methods and systems for displaying content on devices and more particularly for displaying mobile advertisement content on devices such as smartphones, tablets, and other mobile devices.

2. Description of the Related Art

Mobile advertising is considered different from traditional advertising since customers may be accurately targeted (using their mobile number, location, and mobile operator attributes) and ad viewership (impressions) may be accurately measured. These two points may provide the needed stimulus for advertisers/ad agencies to more quickly adopt mobile advertising. Conventionally, mobile marketing services and solutions (provided to clients and partners) include Short Message Service (SMS) advertising and comprehensive mobile advertising services.

### SUMMARY

A mobile advertising platform is disclosed herein which can be used to more efficiently and profitably deliver mobile marketing services and solutions. The mobile advertising platform may be a comprehensive mobile advertising technical and business platform, offering to fill the void between advertisers/Ad agencies and targeted audience in mobile advertising. The mobile advertising platform may deliver mobile ads to subscribers once integrated with existing network servers. The mobile advertising platform would include all the needed modules and services (e.g., for profile collection and management at the initial stages to managing advertising campaigns with accurate tracking and monitoring at the latter stages). Accordingly, the mobile advertising platform would be an excellent ad-enabled application and would allow for easy integration and cross platform strategy using mobile marketing.

Accordingly, a non-limiting embodiment provides a system for displaying content on a device, the system including: a device memory storing a device user profile; and a processor coupled to the device memory and programmed to: (i) retrieve a plurality of contents from one or more servers and store the retrieved plurality of contents in the device memory; (ii) read the device user profile from the device memory; (iii) detect occurrence of a device-related event; (iv) determine, based on the detected occurrence of the device-related event and the read device user profile, presentation content from the stored plurality of contents; and (v) display, on a device display, the determined presentation content.

The plurality of contents may include mobile advertisement contents.

The device related event may be one of: the device receiving a call, the device making a call, the device sending a message, and the device receiving a message.

The device-related event may be the device making a call, and the processor may be programmed to display the presentation content while the device is waiting for a called party to answer the call.

The processor may be programmed to determine the presentation content from the stored plurality of contents further based on timing of the detected device-related event.

Another non-limiting embodiment provides a method of displaying content on a device, the method including: retrieving, using one or more processors, a plurality of contents from one or more servers and storing the retrieved plurality of contents in a device memory; reading a device user profile from the device memory; detecting occurrence of a device-related event; determining, based on the detected occurrence of the device-related event and the read device user profile, presentation content from the stored plurality of contents; and displaying, on a device display, the determined presentation content.

Another non-limiting embodiment provides a non-transitory computer readable medium storing a program, which when executed by a processor causes the processor to execute a method of displaying content on a device, the method including: retrieving, using one or more processors, a plurality of contents from one or more servers and storing the retrieved plurality of contents in a device memory; reading a device user profile from the device memory; detecting occurrence of a device-related event; determining, based on the detected occurrence of the device-related event and the read device user profile, presentation content from the stored plurality of contents; and displaying, on a device display, the determined presentation content.

### BRIEF DESCRIPTION OF DRAWINGS

FIG. 1 illustrates a network including the different servers that are part of a mobile advertising platform, according to a non-limiting embodiment;

FIG. 2 is a diagram illustrating the interactions of various entities using the mobile advertising platform and delivery of various types of advertisements to the end user using various delivery methods according to a non-limiting embodiment;

FIG. 3 is a diagram illustrating the various stakeholders that may orchestrate and/or manage activities in the advertising process in the mobile advertising platform, in accordance with a non-limiting embodiment;

FIG. 4 is a flowchart showing the functionality of a module to download ad content and store the downloaded content in a mobile device local database;

FIG. 5 is a flowchart showing the functionality of a module to collect user profiles to deliver targeted content;

FIG. 6 is a flowchart showing the functionality of a module to monitor events for receiving/making a call, sending short messages, and sending multimedia messages, according to a non-limiting embodiment; and

FIG. 7 is a flowchart showing the functionality of a module to render content on a device screen based on the time and event.

### DETAILED DESCRIPTION OF EXEMPLARY EMBODIMENTS

All terms including descriptive or technical terms which are used herein should be construed as having their plain and ordinary meanings. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description. Thus, the terms used herein have to be defined based on the meaning of the terms together with the description throughout the specification.

Also, when a part “includes” or “comprises” an element, unless there is a particular description contrary thereto, the part may further include other elements, not excluding the other elements. In the following description, terms such as “unit” and “module” indicate a unit for processing at least one function or operation, wherein the unit and the block may be embodied as hardware or software or may be embodied by combining hardware and software.

One or more exemplary embodiments will now be described more fully with reference to the accompanying drawings. However, the one or more exemplary embodiments may be embodied in many different forms, and should not be construed as being limited to the exemplary embodiments set forth herein. Rather, these exemplary embodiments are provided so that this disclosure will be thorough and complete, and will fully convey the concept of the one or more exemplary embodiments to those of ordinary skill in the art. In the following description, well-known functions or constructions are not described in detail since they would obscure the one or more exemplar embodiments with unnecessary detail, and like reference numerals in the drawings denote like or similar elements throughout the specification.

It will be readily understood that the components of the present invention, as generally described and illustrated in the figures herein, may be arranged and designed in a wide variety of different configurations. Thus, the following more detailed description of the embodiments as represented in the figures, is not intended to limit the scope of the invention, as claimed, but is merely representative of selected embodiments of the invention.

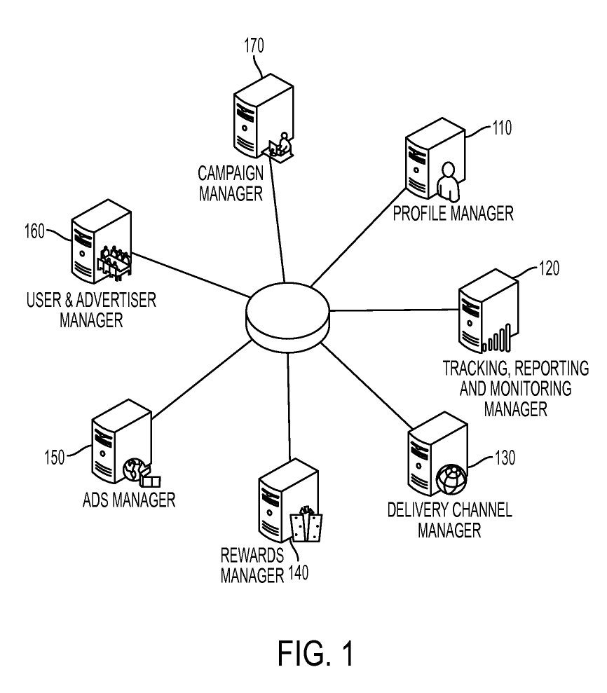

Referring now to FIGS. 1-7, methods and systems for displaying content such as advertisement content on devices will be described.

FIG. 1 illustrates a network including the different servers that are part of a mobile advertising platform 100, according to a non-limiting embodiment. Each server is responsible for managing specific aspects of the mobile advertising process, as discussed below.

Profile Manager 110

The profiles manager 110 is responsible for managing opt-in profiles. When customers opt-in to the ads service, the user will be added to the database with attributes to help in creating targeted campaigns. The profile could be enhanced later by editing existing profile attributes, adding new attributes or deleting them. New attributes could be introduced dynamically if the need arises. If there is an existing list of profiles outside of the mobile advertising platform, it could be added to the system and attributes mapped to database attributes via import web tool.

Profile attributes includes but not limited to:

Mobile number

Mobile operator

Country

City

Area within city

Gender

Age

Nationality

Interests

Income

Education level

Shopping behavior

Peak hour calls

Therefore, advertisers/agencies may select the proper target audience for their campaign. The mobile advertising platform allows advertisers/agencies to freely select their target audience based on general (age, gender, location, etc.) or detailed (shopping behavior, peak hour calls . . . ) profile attributes.

Tracking, Reporting and Monitoring Manager 120

The mobile advertising platform includes a tracking, reporting, and monitoring manager 120 which tracks the delivery status of ads to a campaign target audience and shows delivery results to advertisers/agencies in real time reports. The mobile advertising platform tracks the ads delivery by:

Verifying SMS delivery reports from SMPP connections (impressions on SMS)

Count number of url clicks if SMS contains a URL

Verifying MMS delivery status from MM7 connections (impressions on MMS)

Count impressions of ad when viewed after receiving/making a call

Count clicks on ads when using mobile advertising application

A real-time integrated dashboard may also be used to track real time campaign progress.

Delivery Channel Manager 130

The mobile advertising platform includes a delivery channel manager 130 which delivers Ads on different mobile delivery channels. The platform offers several channels and keeps adding new creative, innovative, revenue-generating, and attractive channels over time based on customer needs.

### Mobile Advertising Platform Offers Several Types of Delivery Channels:

SMS

MMS

WAP Push messages

SMS Tails

MMS Tails.

SMS Tailed Replies—automatic notifications messages.

MMS Tailed Replies—automatic notifications messages.

Mobile WEB Banners

Sponsored, discounted, free calls

On Dial (Displaying an image when dialing a number).

On Receive (Displaying an image when receiving a call).

On Background (Allows for changing of handset background image).

On sending SMS (Displaying an image when sending SMS).

On Sending MMS (Displaying an image when sending MMS).

Rewards Manager 140

The mobile advertising platform model may reward all opt-in profiles when they first opt-in the service and later when they receive ads. Therefore, a dedicated server such as the rewards manager 140 is in place to:

1—Define opt-in reward: mobile operator can define opt-in reward which the customer may collect it immediately after opt-in:
A. Free internet or data bundle
B. Free or discounted voice calls
C. Free SMS and MMS
D. Discounts on mobile devices sold by mobile operator

2—Campaign rewards: advertiser can define a reward for a specific campaign and customer should receive ads to collect points and redeem reward:
A. Define needed points to earn a reward (reward 100 SMS, 10 minutes of voice calls or 100 MB data if profile receive 100 ads)
B. Define earned points on each delivery channel. Example: “anyone receives an Ad as SMS earns 10 points”, “anyone clicks on URL in SMS receives 20 point”, “anyone replies to SMS Ad receives 15 points”, etc.

The rewards manager may offer the below programs that can be used to reward customers

1—Discount program: Provide users with exclusive discounts by brands in the market

2—Deals program: This program offers a short and sweet shopping experience, in which customer get introduced to the latest hot deals offered by brands exclusive to mobile advertising platform opt-in database

3—Rewards club: This program intends to increase loyalty of opt-in profiles where customer can redeem points he collected for the to get a reward, where each reward can be exchanged with a certain number of point

Ads Manager 150

Any advertiser or advertising agency can manage their own Ads content (text, multimedia) through the ads manager 150. In the mobile world an Ad can be:

1—Text (fitting as USSD and SMS text content)

2—Multimedia (Image, audio and video) fitting as MMS content, content for on receiving/making a call.

User and Advertiser Manager 160

The user and advertiser manager 160 is responsible for managing users' accounts of the platform: administrator, media agency, advertiser and publisher—different types of accounts are available for different roles and responsibilities.

Campaign Manager 170

The campaign manager 170 integrates all the above-described mobile advertising platform servers. The campaign manager uses target audience, Ad content, delivery channel, and rewards to create and run a mobile campaign.

The campaign manager 170 is mainly responsible for the following:

1—Managing Campaigns: Add/Create, Update, Copy, Delete, Pause and Resume campaigns.

2—Campaigns Approval: approving campaign by mobile operator.

3—Launch Campaigns: responsible for launching campaigns into action.

The Advertising campaign can be created by defining the campaign basic info: name, description, start and end date, ads frequency, schedule with recurrence and Budget. After that, the advertiser may assign delivery channels, and add content related to selected delivery channels.

Targeting could be a key aspect for the success of the campaign-different targeting attributes may affect the outcome of the campaign. So an advertiser can create test campaigns for a set of MSIADNs to find out the best attributes and time to create the main campaign.

The expected number of opt-in customers in the target segment is calculated and displayed to the advertiser depending on targeting attributes, after which the advertiser can save the campaign.

The mobile operator may review campaign ad content and approve it for final launch. The mobile operator may allow for 48 hours to launch any campaign depending on number of campaigns in the pipeline.

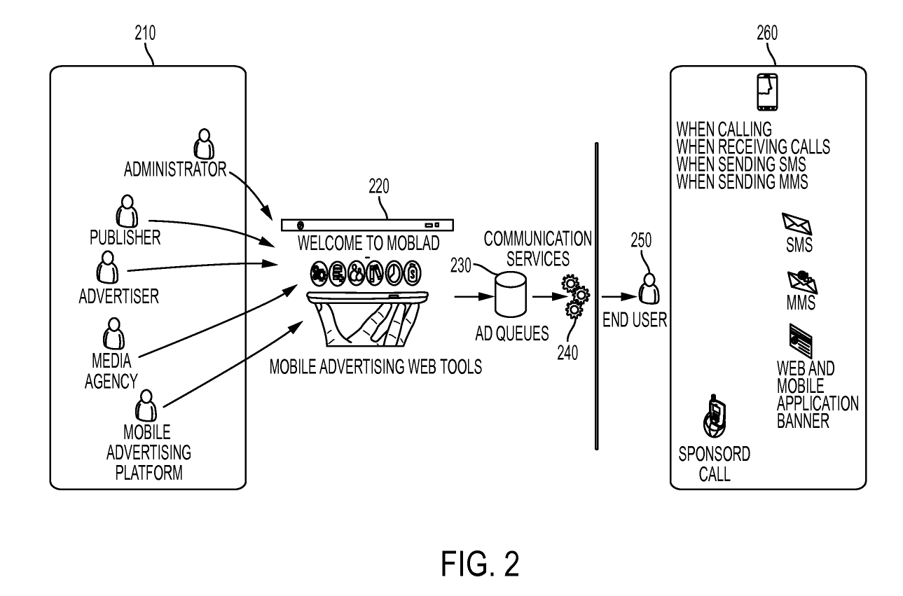

FIG. 2 is a diagram illustrating the interactions of various entities using the mobile advertising platform and delivery of various types of advertisements to the end user using various delivery methods according to a non-limiting embodiment.

FIG. 2 depicts the mobile advertising platform with stakeholders 210 and 250. Stakeholders use the mobile advertising platform with different roles and responsibilities to achieve a certain goal. For example, advertisers and media agencies may use the mobile advertising platform to create, launch, and track ad campaigns while a publisher may allow ads to be viewed on web sites, mobile applications, games, etc.

The mobile advertising web tools 220 will facilitate a web tool to create, launch and track ad campaigns. All ads will be available for delivery to end users in different Ad Queues 230, for example, there are queus for SMS, MMS, on receive . . . and for other delivery channels.

The mobile advertising platform uses communication services 240 to deliver different types of ads. For example, SMS is used to deliver SMS ad campaigns while data and Internet channel(s) are used to deliver ad content for on receive call ad campaign to an End User 250.

The End user 250 will receive the ad campaign sent to him from advertiser and the ad will be displayed depending on delivery channel 260.

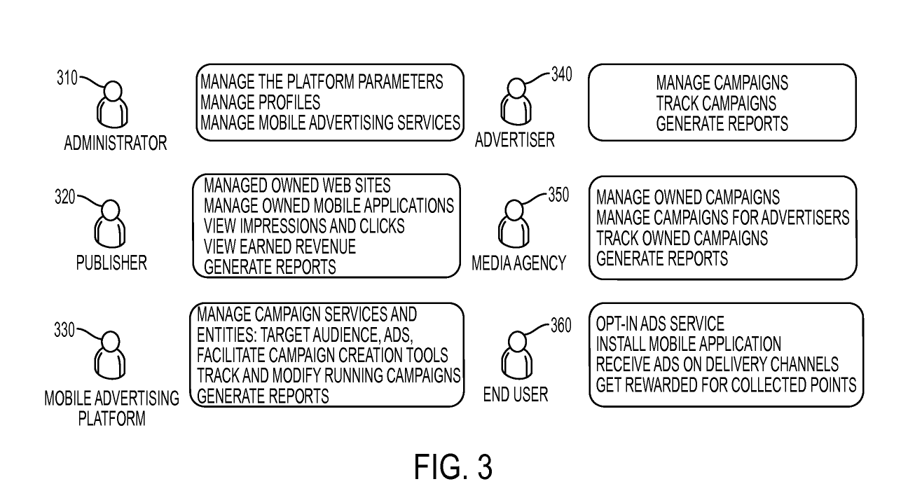

FIG. 3 is a diagram illustrating the various stakeholders that may orchestrate and/or manage activities in the advertising process in the mobile advertising platform, in accordance with a non-limiting embodiment.

As shown in FIG. 3, various stakeholders manage different activities in the mobile advertising process. For example, an administrator 310 manages the platform parameters, manages the user profiles, and manages the connections between the various entities in the mobile advertising platform. The publisher 320 manages owned Wireless Application Protocol (WAP) suites, manages owned mobile applications, views impressions and clicks, and views earned revenue. The mobile advertising platform controller 330 manages campaign entities, target audience, advertisements, campaign attributes, view ad inventory, track launched campaigns, and edit launched campaigns. The mobile advertising platform controller 330 can also manage other campaigns.

The advertiser 340 manages campaigns it owns and tracks those campaigns. The advertisement agency 350 manages its owned campaigns, manages campaigners for advertisers, tracks its owned campaigns and tracks campaigns for advertisers.

The end user 360 can opt in to the services provided by the mobile advertising platform, install an application for on-device channels of the mobile advertising platform, receive advertisements on different delivery channels, collect points for receiving advertisements, and receive/redeem rewards based on the collected points.

The mobile advertising platform includes the following:

Service Features

Profile Management.

Audience Targeting.

Ads Management.

Campaign Management.

Ad Inventory.

Rewards Management.

Profile Ranking.

Campaign rating engine.

Interactive management.

Content Management.

Campaign monitoring, tracking, tuning and management.

Opt in—Opt out management.

Blocked Ads management.

Intelligent reporting.

On Device Certified Ads Application

Campaign Functionalities

Opt in, Non-intrusive campaigns.

A pre-programmed maximum number of ads to be sent to each profile.

Rewarding profiles for every ad viewed

Channels

SMS

Multimedia Message Service (MMS)

WAP Push messages

SMS Tails

MMS Tails.

SMS Tailed Replies—automatic notifications messages.

MMS Tailed Replies—automatic notifications messages.

Mobile WEB (World Wide Web)/WAP Banners

Sponsored, discounted, free Global System for Mobile Communications (GSM) calls

On Dial (Displaying an image when dialing a number).

On Receive (Displaying an image when receiving a call).

On Background (Allows for changing of handset background image).

On sending SMS (Displaying an image when sending SMS).

On Sending MMS (Displaying an image when sending MMS).

Operator Logo (displaying ad in operator logo space).

Ad funded content, including:
Injecting ad images in games & videos.
Sponsorship by including ad text & images within content.

Support of Precise Targeting Capacities

Displaying the ad according to
Time, Day, Date, and scheduling recurrences.
Area, Operator Coverage and Handset Model.
Profile Info. : Age, gender, interests, income . . . etc.

Offer of Focused Tracking and Reporting

Campaign Progress Monitoring & Analysis.

Per View, per click and per Action Tracking.

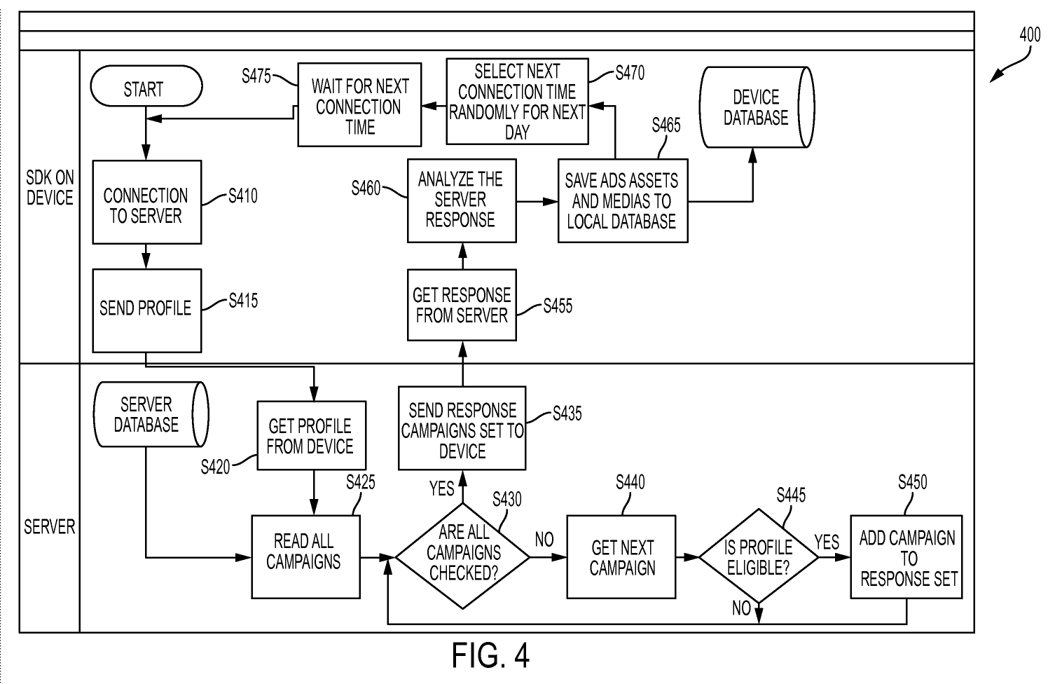

FIG. 4 is a flowchart showing the functionality of a module to download ad content and store the downloaded content in a mobile device local database.

The module 400 relates to downloading the advertisement contents and assets via Hyper Text Transfer Protocol. The download model consists of request from the mobile device and a response from a remote server. The module 400 communicates with a remote server, it sends a request that contains information that helps the server to decide if ad assets should be downloaded to the mobile device or not. Information sent by mobile device is the profile of the user that contains: device identifier, gender, age, and country.

If the profile is eligible to be part of an ad campaign the server will respond to the device request with ad assets that will be downloaded by mobile device and stored in device local database to be accessed later even if the device is not connected to the communications network. If the profile is ineligible to be part of any ad campaign, the server will respond with status indicating that no ads are targeted to the provided profile.

In either case, the device will retry to send a request again according to a pre-configured time period to ask for additional ads for the user. The downloaded assets contain all information about the Ad such as schedule and events types in addition to the high quality media for the Ad. These assets are pulled one time every day to present the way in which the Ad will be displayed on events. All that assets are stored in a local database on the device. For example, the software development kit (SDK) of the mobile advertising platform may select a random time between lam-ham to connect to a remote server in order to pull the Ads.

When the SDK connects, the server will deliver the Ads for one day based on the user profile and targeting. All Ads assets and media will be saved on the local device database. After saving the received Ads, a background job starts every hour to check the schedule of the Ads. Every hour the device reads all saved Ads and checks the schedule of each Ad-any campaign that has a schedule including the current hour will be marked as active. The other campaigns, i.e., the campaigns whose schedule does not include the current hour, will be marked as inactive, and all other campaigns whose maximum hour in schedule is less than current hour will be marked as finished and will be deleted from the device.

In particular, as shown in FIG. 4, first the device connects to the remote server (S410). Then the device sends the profile to the server (S415). The server receives the profile from the device (S420). The server reads all available campaigns by retrieving/reading them from a server database, based on the profile information received from the device (S425). The server determines if all campaigns have been checked based on the profile information (S430). If not, then the next campaign is checked (S440) and it is determined if the currently examined campaign is profile eligible (S445). If so, the campaign is added to the response set (S450). Once it is determined that all campaigns have been checked (S430), then a response containing a campaign set is sent to the device (S435). The campaign set includes all campaigns that match the profile information and any other criteria used by the server to select the campaigns.

The device receives the response including the campaign set from the server (S455). The device analyzes the server response (S460) and then saves the information included in the campaign set to a device database (S465). The saved information may include Ads, assets, and media related to the ads. Then, a next connection time (for connecting to the server) to again carry out the above functionality of the module 400 is randomly or fixedly selected for the next day (S470). The next connection time is then waited for to connect to the server again (S475).

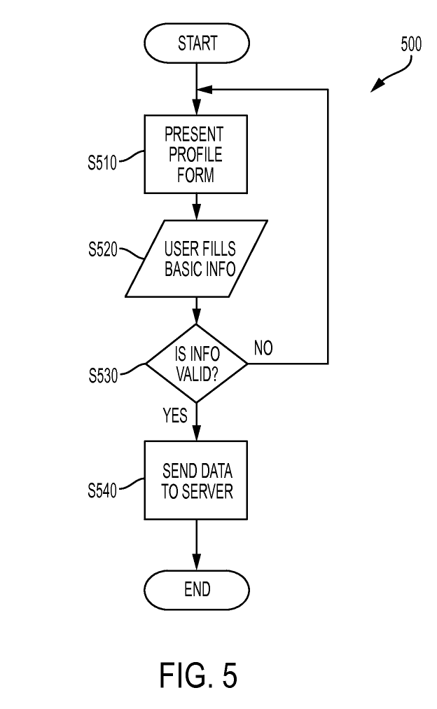

FIG. 5 is a flowchart showing the functionality of a module to collect user profiles to deliver targeted content.

The ad creation, delivery and display are highly affected by profile information of a user with a mobile device. In order to create a marketing campaign with high performance and be viewed by relevant users, the user should give consent to receive marketing content and ads. Moreover, the user also is requested to provide his profile to the system via a module 500. The requested profile information includes device identifier, gender, age and country.

The purpose of the device identifier is to make a unique profile for that user in addition to knowing how many applications installed in the device are compatible with the SDK of the mobile advertising platform. This information will be used later to know which SDK should display the Ad on the event. In order to collect the user profile, the system in this module will show non-intrusive and user experienced form that asks the end user to fill in some basic information for one time. Of course, the user may be able to update the information at a later time. This form in addition to some other data such as country, mobile network code, etc. will be delivered to the server side in order to build the user profile which will be used in ads targeting.

In particular, the module 500 would execute at least the following operations: First, the profile form is presented to the user (S510). Then the user fills in the basic information (S520). Next, the module 500 determines whether the filled out information is valid (S530). If valid, then data from the filled out form is sent to the server (S540). If the information is invalid, then the form is presented again to the user (S510), but this time, the module 500 may provide additional information to the user to fill out valid information.

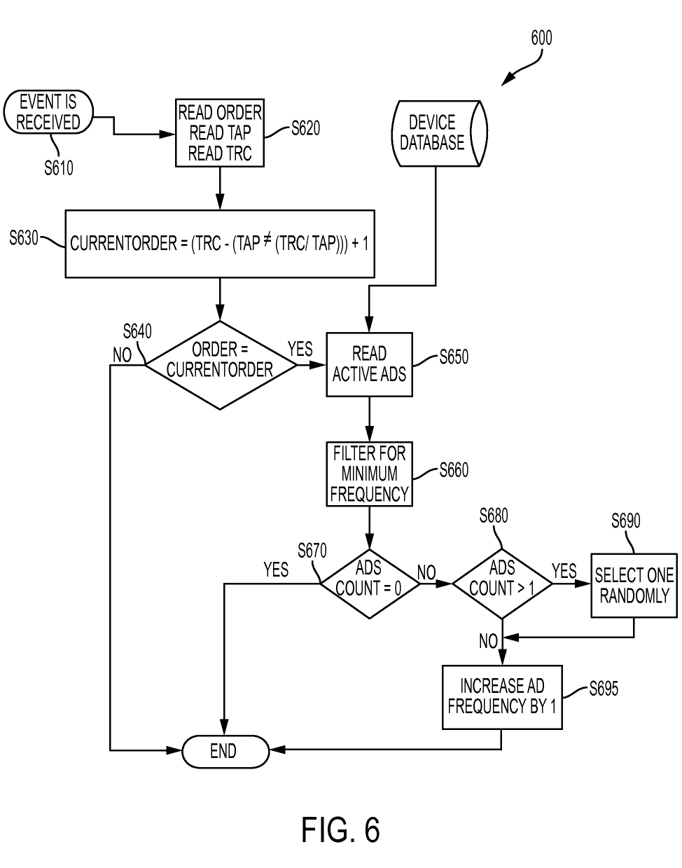

FIG. 6 is a flowchart showing the functionality of a module to monitor events for receiving/making a call, sending short messages, and sending multimedia messages, according to a non-limiting embodiment.

When a user is eligible for a campaign, the device will download ad information and assets like start date, time frequency, and ad images, and all data is stored in a local device database to be accessed immediately even if the device is no7t connected to the communications network as described above. The module 600, shown in FIG. 6, depends on events to display the ad image to the user, these events include but are not limited to; receiving/making a phone call, sending a text message and sending multimedia messages. There is an event monitor that continuously monitors for events at the mobile device in order to handle the detected events immediately.

In particular, handling events causes the right ad image to be displayed depending on the date and time frequency. The mobile device may contain more than one copy of the SDK installed depending on applications installed by the user that uses the SDK. Each SDK knows its order and total number of applications that use the SDK on the device when it connects to the server. The events occur frequently in a mobile device, when the device fires an event for making or receiving a call the event monitor captures that event and dispatches it to the module 600 (S610).

The module 600 checks whether it is its turn or not. First, the module 600 reads an Order and TAP values that are provided by the server in addition to calculated TRC value from local database (S620). The Order number is in the range of integers of the set {1, . . . , TAP}. TAP indicates the total number of applications that use the SDK on the same device. TRC indicates the total number of events that occurred before current event.

Then the CurrentOrder is computed at S630 based on the following formula:

Current Order=(TRC−(TAP*(TRC/TAP)))+1

If the value of (Current Order) equals to (Order), then it is determined that this SDK is responsible for displaying the Ad for this event (Yes at S640).

The SDK reads all active ads that are available for this event (S650). The read active Ads are filtered to get the Ads that have the minimum viewing frequency (S660).

The minimum viewing frequency, viewing frequency of an Ad represents the occurrence of that Ad within hour, the Ads filtered to get the minimum number of occurrences within the current hour.

If there are no Ads left after the filtering, the process ends without display of any Ads (S670). If many Ads have the same viewing frequency (S680); one of them will be selected randomly (S690). Subsequently, the selected Ad will be displayed on the device display. The viewing frequency for the selected Ad will be increased by one to give a chance to other Ads to appear during the next detected event (S695).

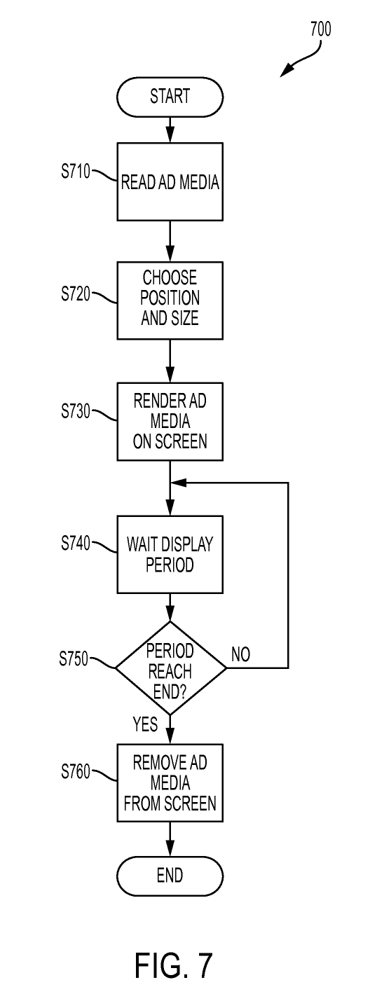

FIG. 7 is a flowchart showing the functionality of a module to render content on a device screen based on the time and event.

When an event is fired/detected like receiving/making a call, sending a text message or sending a multimedia message, module 700 will choose an ad from the device local database (S710). This module uses the ad image/ad media to display the ad on the display. It chooses the right position and size of the target display canvas that is suitable for the received event (S720). Next, the content of the ad image is rendered on the device screen (S730). When the ad image is displayed for a period of time or the user dismisses the ad (S740/S750), the canvas will be removed from the device screen (S760).

As can be appreciated from the above description, the mobile advertising platform software development kit (SDK) is a computer-implemented method to display high quality multimedia content on a mobile device when a mobile device communications event occurs for receiving/making a call, sending short messages and sending multimedia messages. The SDK includes a software processor to be coupled to the mobile device, and the method includes downloading multimedia content from a remote server and storing it in a local device database to be accessed immediately even if the device is not connected to the communications network. Events are monitored for and detected so that the required multimedia content to be displayed on the mobile device screen can be selected. These events include, but are not limited to; receiving/making a phone call, sending/receiving a text message, and sending/receiving a multimedia message.

A device communications event monitor may be included in the system that implements the method for displaying the mobile advertisement on a mobile device. The device communications event monitor can continuously monitor for events from the mobile device in order to take actions which may include: selecting the multimedia file to be displayed to the user when the mobile device communications event occurs depending on the date and time frequency of the content.

The method takes into consideration that the mobile device may contain more than one copy of the SDK installed depending on applications installed by the user that use the SDK. Each SDK knows its order and total number of other SDKs on the device when it connects to the server.

The method includes reading all active multimedia content that are available for the detected event, then filtering the available content to get the Ads that have the minimum viewing frequency. If many Ads have same viewing frequency; one of them will be selected randomly. The viewing frequency for selected multimedia content will be increased by one to give a chance to other contents to appear for next event.

One or more exemplary embodiments may also be embodied as programmed commands to be executed in various computer means, and then may be recorded to a computer-readable storage medium. The computer-readable storage medium may include one or more of the programmed commands, data files, data structures, or the like. The programmed commands recorded to the computer-readable storage medium may be particularly designed or configured for one or more exemplary embodiments. Examples of the computer-readable storage medium include magnetic media including hard disks, magnetic tapes, and floppy disks, optical media including CD-ROMs and DVDs, magneto-optical media including optical disks, and a hardware apparatus designed to store and execute the programmed commands in ROM, RAM, a flash memory, and the like. Examples of the programmed commands include not only machine codes generated by a compiler but also include great codes to be executed in a computer by using an interpreter. The hardware apparatus may be configured to function as one or more software modules so as to perform operations of one or more exemplary embodiments.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope of the inventive concept as defined by the following claims.

1. A system for displaying content on a device, the system comprising:
a device memory storing a device user profile; and
a processor coupled to the device memory and programmed to:
(i) retrieve a plurality of contents from one or more servers and store the retrieved plurality of contents in the device memory;
(ii) read the device user profile from the device memory;
(iii) detect occurrence of a device-related event;
(iv) determine, based on the detected occurrence of the device-related event and the read device user profile, presentation content from the stored plurality of contents; and
(v) display, on a device display, the determined presentation content.

2. The system of claim 1, wherein the plurality of contents comprises mobile advertisement contents.

3. The system of claim 2, wherein the device related event is one of: the device receiving a call, the device making a call, the device sending a message, and the device receiving a message.

4. The system of claim 3, wherein the device-related event is the device making a call, and the processor is programmed to display the presentation content while the device is waiting for a called party to answer the call.

5. The system of claim 4, wherein the processor is programmed to determine the presentation content from the stored plurality of contents further based on timing of the detected device-related event.

6. A method of displaying content on a device, the method comprising:
retrieving, using one or more processors, a plurality of contents from one or more servers and storing the retrieved plurality of contents in a device memory;
reading a device user profile from the device memory;
detecting occurrence of a device-related event;
determining, based on the detected occurrence of the device-related event and the read device user profile, presentation content from the stored plurality of contents; and
displaying, on a device display, the determined presentation content.

7. The method of claim 6, wherein the plurality of contents comprises mobile advertisement contents.

8. The method of claim 7, wherein the device related event is one of: the device receiving a call, the device making a call, the device sending a message, and the device receiving a message.

9. The method of claim 8, wherein the device-related event is the device making a call, and the displaying comprises displaying the presentation content while the device is waiting for a called party to answer the call.

10. The method of 9, wherein the determining comprises determining the presentation content from the stored plurality of contents further based on timing of the detected device-related event.

11. A non-transitory computer readable medium storing a program, which when executed by a processor causes the processor to execute a method of displaying content on a device, the method comprising:
retrieving a plurality of contents from one or more servers and storing the retrieved plurality of contents in a device memory;
reading a device user profile from the device memory;
detecting occurrence of a device-related event;
determining, based on the detected occurrence of the device-related event and the read device user profile, presentation content from the stored plurality of contents; and
displaying, on a device display, the determined presentation content.

12. The non-transitory computer readable medium of claim 11, wherein the plurality of contents comprises mobile advertisement contents.

13. The non-transitory computer readable medium of claim 12, wherein the device related event is one of: the device receiving a call, the device making a call, the device sending a message, and the device receiving a message.

14. The non-transitory computer readable medium of claim 13, wherein the device-related event is the device making a call, and the displaying comprises displaying the presentation content while the device is waiting for a called party to answer the call.

15. The non-transitory computer readable medium of 14, wherein the determining comprises determining the presentation content from the stored plurality of contents further based on timing of the detected device-related event.
